(19) United States
(12) Patent Application Publication
(10) Pub. No.: US 2010/0083129 A1
(43) Pub. Date: Apr. 1, 2010

(54) User Interface for Internet Advertisement

(76) Inventors: Sumit Mishra, Santa Clara, CA (US); Becky Chu, San Jose, CA (US); Vivek Hariharan, Sunnyvale, CA (US); Dean Quan, Playa Vista, CA (US); Graham Harris, Westlake Village, CA (US); Erik Racho, Arcadia, CA (US)

Correspondence Address: Stattler-Suh PC, 60 SOUTH MARKET, SUITE 480, SAN JOSE, CA, 95113, US

(21) Appl. No.: 12/240,765

(22) Filed: Sep. 29, 2008

(51) Int. Cl. G06F 3/048

(52) U.S. Cl. 715/744

(57) ABSTRACT

This patent discloses a system to create a template for Internet advertising utilizing a template server containing graphical user interfaces. The template server may receive instructions to retrieve a SWF object having a first image asset associated with a defined image variable. The template server additionally may receive instructions to replace the first image asset with a second image asset. The second asset automatically may be associated with the defined variable. The template server further may receive instructions to create the SWF object by adding the first image asset and the defined variable to the SWF object.

### BACKGROUND

1. Field

The information disclosed in this patent relates to a system that allows a person to create templates for graphical advertisements utilizing graphical user interfaces.

2. Background Information

The marketing of products and services online over the Internet through advertisements is big business. In February 2008, the IAB Internet Advertising Revenue Report announced that Internet advertising revenues for 2007 were anticipated to exceed US$21 billion. With 2007 revenues increasing 25 percent over the previous 2006 revenue record of nearly US$16.9 billion, Internet advertising presently is experiencing unabated growth. By 2012, spending in online advertising is predicted to reach $50 billion dollars.

For a website publisher whose site gets high traffic with lots of repeat viewers. advertising is a big revenue stream for that publisher. However, the present system of buying and selling online advertising is byzantine, full of inefficient processes and cumbersome legacy solutions where few things work well or work together. These inefficiencies cost the website publisher time and money.

In an example, an ad agency may approach the publisher with one of their clients who desire 2,000,000 impressions for their automobile advertisement. Each time an advertisement loads on a users' computer screen counts as one impression. Once the projected 2,000,000 impressions are secured, the publisher needs to create, test, and deliver the actual advertisement to its own website and those of the subpublishers. The online advertising technology company Adready.com provides a system that includes prebuilt, canned advertising templates that others may access. However, creating, testing, and delivering the advertisement remains a disconnected process full of time consuming manual steps and multiple approval bottle necks to catch the mistakes inherent in any developing advertisement. Typical creation and testing of an advertisement is constrained by personal application system used to create the advertisement and is limited to a specific set of people. Advertisement deliveries typically are made with little connection between the advertisement and the particular viewer of the advertisement.

Large markets with significant inefficiencies are ripe for transformation. The present process of doing advertising business across the increasingly fragmented Internet is surprisingly cumbersome and manual. What is needed is a system to simplify online advertising processes for advertisers, agencies, ad networks, publishers, and others.

### SUMMARY

This patent discloses a system to create a template for Internet advertising utilizing a template server containing graphical user interfaces. The template server may receive instructions to retrieve a SWF object having a first image asset associated with a defined image variable. The template server additionally may receive instructions to replace the first image asset with a second image asset. The second asset automatically may be associated with the defined variable. The template server further may receive instructions to create the SWF object by adding the first image asset and the defined variable to the SWF object.

### BRIEF DESCRIPTION OF THE FIGURES

FIG. 1 is a block diagram illustrating a system 100.

FIG. 2 is an example layout of ads graphical user interface (GUI) 200.

FIG. 3 is an example expansion of action button 250.

FIG. 4 is an example layout of Shockwave Flash (SWF) GUI 300.

FIG. 5 is a method 500 to define a file format object 364 (FIG. 15) utilizing system 100.

FIG. 6 is an example layout of SWF GUI 300 containing storage control information.

FIG. 7 is an example layout of image file dialog box 400.

FIG. 8 is an example layout of image file dialog box 400 containing the file “Silver Birch Metallic”.

FIG. 9 is an example layout of SWF GUI 300 containing the file “Silver Birch Metallic.gif”.

FIG. 10 is an example layout of SWF GUI 300 with update SWF button 350 enabled.

FIG. 11 is an example layout of SWF GUI 300 with Silver Birch Metallic.gif displayed in preview window 346 and the file parameters displayed in preview parameters 348.

FIG. 12 is an example layout of SWF GUI 300 with both Silver Birch Metallic.gif and ImageName2.gif displayed in preview window 346 and the file parameters displayed in preview parameters 348.

FIG. 13 is an example layout of SWF GUI 300 with Silver Birch Metallic.gif, ImageName2.gif, and Dynamic txt w txt box.jpg displayed in preview window 346 and the file parameters displayed in preview parameters 348.

FIG. 14 is an example layout of SWF GUI 300 with an edit field may be displayed under text value 342.

FIG. 15 is an example layout of SWF GUI 300 with the text “Or call (123) 456-6789” displayed in both text value 342 and preview window 346 and with text flash variable “phoneNumber_var” displayed in text flash variable 344.

FIG. 16 is a method 600 to create a new template 366 (FIG. 23) for Internet advertising utilizing a system 100 containing graphical user interfaces.

FIG. 17 is an example layout of new template GUI 700.

FIG. 18 is an example layout of new template GUI 700 with template details pane 726.

FIG. 19 is an example layout of new template GUI 700 with asset identification pane 728.

FIG. 20 is an example layout of image file dialog box 400 on being accessed through replace image hypertext link 750.

FIG. 21 is an example layout of new template GUI 700 with new image asset “Automobile Truck 3” swapped into image cell 748 and into preview window 346.

FIG. 22 is an example layout of new template GUI 700 with text drop down list 762 exposed.

FIG. 23 is an example layout of new template GUI 700 with the template phone number revised.

FIG. 24 illustrates a network environment 800 for operation of system 100.

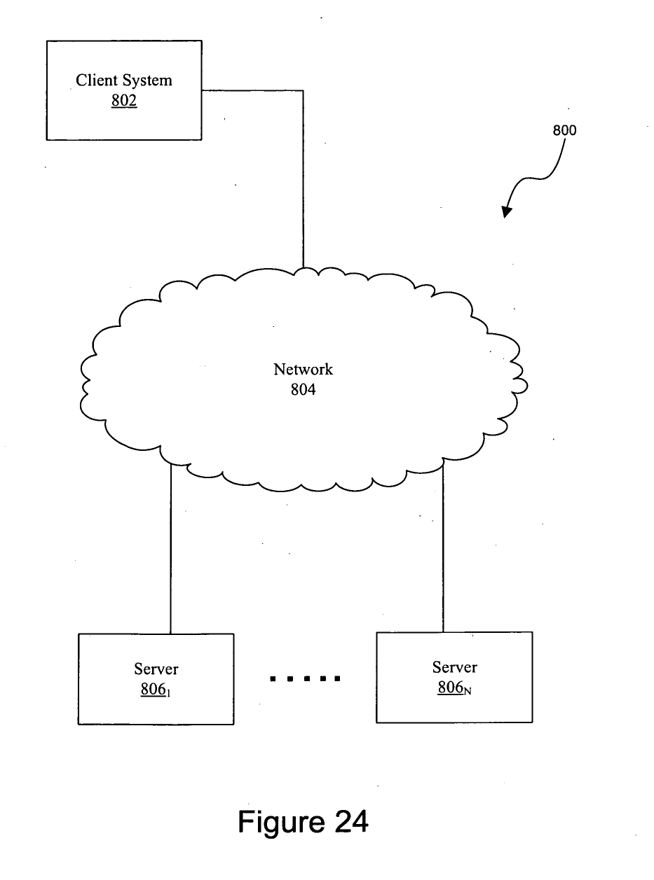

### DETAILED DESCRIPTION

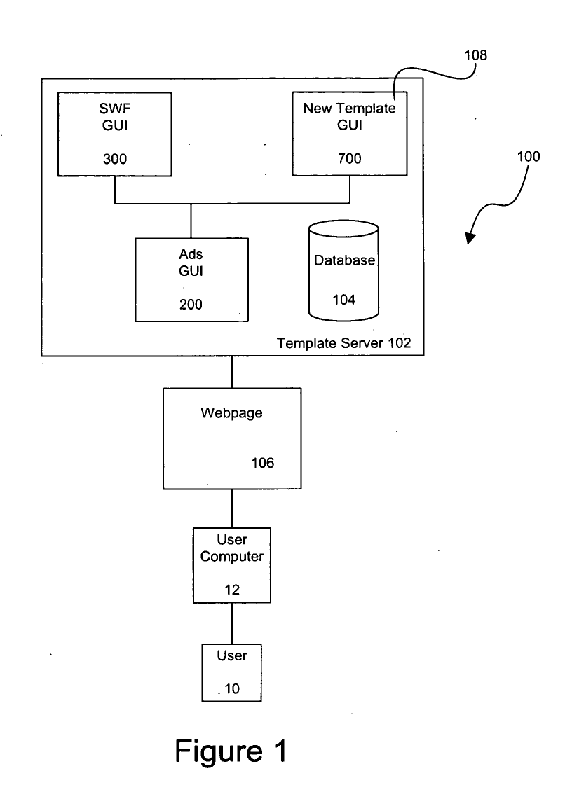

FIG. 1 is a block diagram illustrating a system 100. System 100 may be a group of independent but interrelated elements that may work to assist a user 10 to create an advertisement for subsequent display on the Internet. System 100 may be an open, automated web based process to create file format objects and build new and different templates for standard graphical ads based on those file format objects. Rather than being constrained by the system or to a specific set of people, web based system 100 may be open to a large set of people, including agencies and advertisers and other users 10 having a user computer 12. By making template creation open and easy, more templates may be built that, in turn, may lead to building additional graphical ads. Here, once user 10 creates the templates, the templates may be utilized to create graphical ads more easily by swapping in and out assets like background images, logos and headlines.

System 100 may include a template server 102, a database 104, a webpage 106, and graphical user interfaces 108, such as an ads graphical user interface (GUI) 200, a Shockwave Flash (SWF) GUI 300, and a new template GUI 700. In operation, user 10 may engage user computer 12 to retrieve webpage 106 from database 104 of template server 102. One of ads GUI 200, SWF GUI 300, and new template GUI 700 may appear on webpage 106. User 10 may interact with graphical user interface 108 to create/modify SWF object and/or a template to produce an advertisement, where the SWF object, the template, and the advertisement may be stored in database 104 for subsequent processing.

Template server 102 may include a web server computer program to accept Hypertext Transfer Protocol (HTTP) requests from user computer 12 and to serve an HTTP response along with optional data content to user computer 12. Template server 102 may include both a content management system and a computer that runs the web server computer program. Template server 102 may construct (X)HTML for each webpage 106 when it is requested by a user computer 12. Template server 102 additionally may include a template engine to combine one or more templates with a data model to produce one or more result documents. The template engine may be software or a software component that produces formatted output, such as documents, web pages, and source code, either in whole or in fragments. The templates may include HTML elements and links and may be organized by their content category and structure.

Database 104 may be a device to store a structured collection of data. Database 104 may be responsive to a database management system. In an example, database 104 may house GUIs 108 and inputs received by template server 102 from user 10.

Webpage 106 may be a resource of information in template server 102 accessed through a web browser. A web browser is a software application that may enable user 10 to display and interact with text, images, videos, music, and other information located on webpage 106. The information may be in a HyperText Markup Language (HTML) format or Extensible Hypertext Markup Language (XHTML) format. Webpage 106 may provide navigation to other webpages through hypertext links.

Graphical user interfaces 108 may be user interfaces that may allow user 10 to interact with template server 102. Graphical user interfaces 108 may include graphical icons, visual indicators, and other graphical elements to represent information and actions available to user 10. User 10 may take action through direct manipulation of the graphical elements. The user interface may allow users 10 to manipulate system 100 through input and allow system 100 to output the effects of the manipulations by user 10.

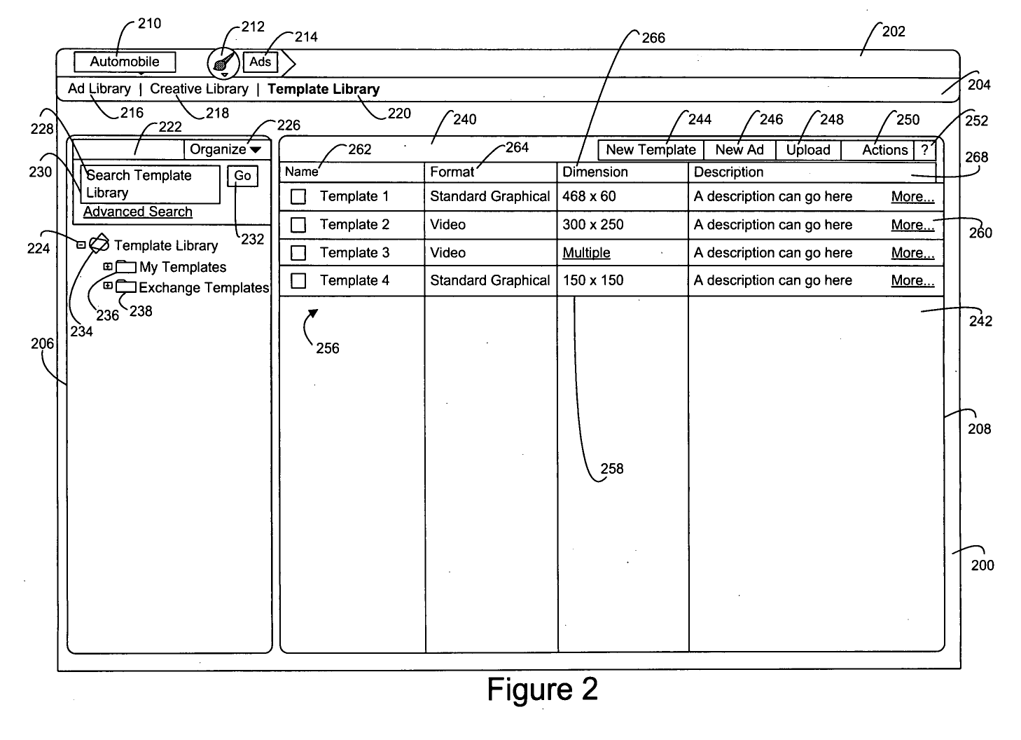

FIG. 2 is an example layout of ads graphical user interface (GUI) 200. Ads GUI 200 may be a user interface that may allow user 10 to interact with existing templates and navigate to other areas of system 100. Ads GUI 200 may include a navigation bar 202 and a library bar 204 positioned above a tree view pane 206 and a template library grid view pane 208.

Navigation bar 202 may be a subregion of ads GUI 200 that may contain hypertext links to allow user 10 to navigate between pages of website 106. Navigation bar 202 may include a project selection button 210, a paint button 212, and an ads button 214. Each button may be a GUI widget that may display an information arrangement changeable by user 10. For example, pressing project selection button 210 may allow user 10 to move between advertisement projects, pressing paint button 212 may allow user 10 to bring up a graphics painting program, and pressing ads button 214 may cause ads GUI 200 to be displayed on webpage 106.

Library bar 204 may be a subregion of ads GUI 200 that may contain hypertext links which allow user 10 to navigate between pages of website 106. Library bar 204 may include an ad library button 216, a creative library button 218, and a template library button 220. Pressing ad library button 216 may bring up a repository of existing advertisements, pressing creative library button 218 may bring up a repository of products from designers directly involved in a creative marketing process, and pressing template library button 220 may bring up a repository of templates, such as illustrated by FIG. 2.

Tree view pane 206 may be a layer in a build up of ads GUI 200 that may present user 10 with a list of common actions and destinations. The common actions and destinations may be relevant to the current directory or file(s) selected. Tree view pane 206 may be positioned on the left-hand side of webpage 106 and include an organize menu block 222 positioned above a tree view 224.

Organize menu block 222 may include an organize button 226, a search text box 228, an advanced search hypertext link 230, and a search go button 232. Pressing organize button 226 may reveal a menu having options to revise structure and order of templates. Search text box 228 and, when selected, advanced search hypertext link 230 each may be configured to receive inputs to formulate a request to template server 102 to find something. Pressing search go button 232 may cause template server 102 to seek out an item or items requested through search text box 228 or advanced search hypertext link 230.

Tree view 224 may be a GUI element (widget) that may present a hierarchical view of information. Each item may have a number of subitems that may be visualized by indentation in a list. In the example of FIG. 2, tree view 224 includes a template library node 234 with both a my templates node 236 and an exchange templates note 238 related to template library node 234 as subfolders. Each may be expanded to reveal subitems, if any exist, and collapsed to hide subitems.

Template library grid view pane 208 may be a layer in a build up of ads GUI 200 that may present user 10 with a menu action bar 240 and a template grid view 242. Template library grid view pane 208 may be positioned on the right-hand side of webpage 106 below library bar 204. In an example, navigation bar 202, library bar 204, tree view pane 206, and template library grid view pane 208 substantially may cover a footprint of ads GUI 200.

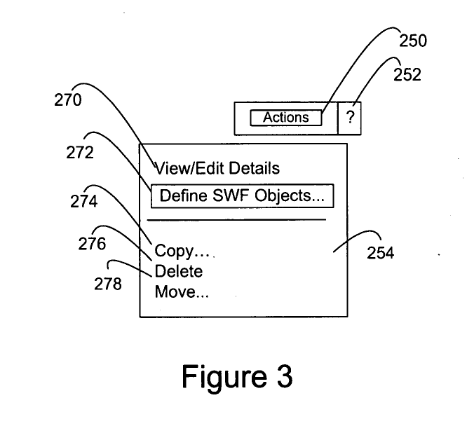

Menu action bar 240 may include a new template button 244, a new ad button 246, an upload button 248, an actions button 250, and a help button 252. Pressing new template button 244 may bring up new template GUI 700, pressing new ad button 246 may start a process to create a new advertisement, and pressing upload button 248 may bring up window through which files on user computer 12 and elsewhere may be accessed. In addition, pressing actions button 250 may reveal an actions drop-down list 254 (FIG. 3), and pressing help button 252 may bring up resources that give assistance to user 10.

Template grid view 242 may present template files 256 in an arrangement of columns 258 and rows 260. Each template file 256 may be characterized by a template name 262, a template format 264, a template dimension 266, and a template description 268. Template name 262 and template description 268 may include any set of character identifiers that may have meaning to user 10. Template format 264 may be text, standard graphical, or video advertisement format. Template dimension 266 may be various ad sizes, usually measured in Interactive Marketing Units (IMU). Table I below includes standard Internet Advertising sizes from the Internet Advertising Bureau (IAB):

TABLE I
IAB Standard Advertising Graphic Sizes

| Rectangles and Pop-Ups | Banners and Buttons | Skyscrapers |
|---|---|---|
| 300 × 250 IMU (Medium Rectangle) | 468 × 60 IMU (Full Banner) | 160 × 600 IMU (Wide Skyscraper) |
| 250 × 250 IMU (Square Pop-Up) | 234 × 60 IMU (Half Banner) | 120 × 600 IMU (Skyscraper) |
| 240 × 400 IMU (Vertical Rectangle) | 88 × 31 IMU (Micro Bar) | 300 × 600 IMU (Half Page Ad) |
| 336 × 280 IMU (Large Rectangle) | 120 × 90 IMU (Button 1) | 120 × 600 Skyscraper |
| 180 × 150 IMU (Rectangle) | 120 × 60 IMU (Button 2) | 160 × 600 Wide Skyscraper |
| | 120 × 240 IMU (Vertical Banner) | 250 × 250 Square |
| | 125 × 125 IMU (Square Button) | 300 × 250 Inline |
| | 728 × 90 IMU (Leaderboard) | 336 × 280 Large Rectangle |
| | | 468 × 60 Banner |
| | | 728 × 90 Leaderboard |

In the example provided, user 10 may desire to define an advertisement objects. The advertisement object may include a variety of graphics file formats, such as Shockwave Flash file or a Scalable Vector Graphics file. Shockwave Flash is a partially open file format for multimedia, including vector graphics utilized in advertisements. Shockwave Flash (or SWF, pronounced “swiff”) files may contain animations or applets of varying degrees of interactivity and function. Since SWF files may be small enough for publication on user computer 12 and are from a partially open file format, SWF presently is the dominant format for displaying advertisement graphics on the Internet. System 100 preferably may utilize SWF files, but may utilize other file formats as well. To define an advertisement object from ads GUI 200, user 10 may select action button 250.

FIG. 3 is an example expansion of action button 250. As noted above, pressing actions button 250 may reveal an actions drop-down list 254. Drop-down list 254 may be a user interface control GUI element that may allow user 10 to choose one action from a list of action. When actions drop-down list 254 is inactive, actions drop-down list 254 may display a single value as illustrated in FIG. 2. When activated, actions drop-down list 254 may drop down to display view/edit details link 270, define SWF objects link 272, copy link 274, delete link 276, and move link 278. Display view/edit details link 270 may allow user 10 to modify template name 262, template format 264, template dimension 266, and/or template description 268 of a selected template file 256. Copy link 274, delete link 276, and move link 278 respectively may copy, delete, and move a selected template file 256. Selecting define SWF objects link 272 may bring SWF GUI 300 into webpage 106.

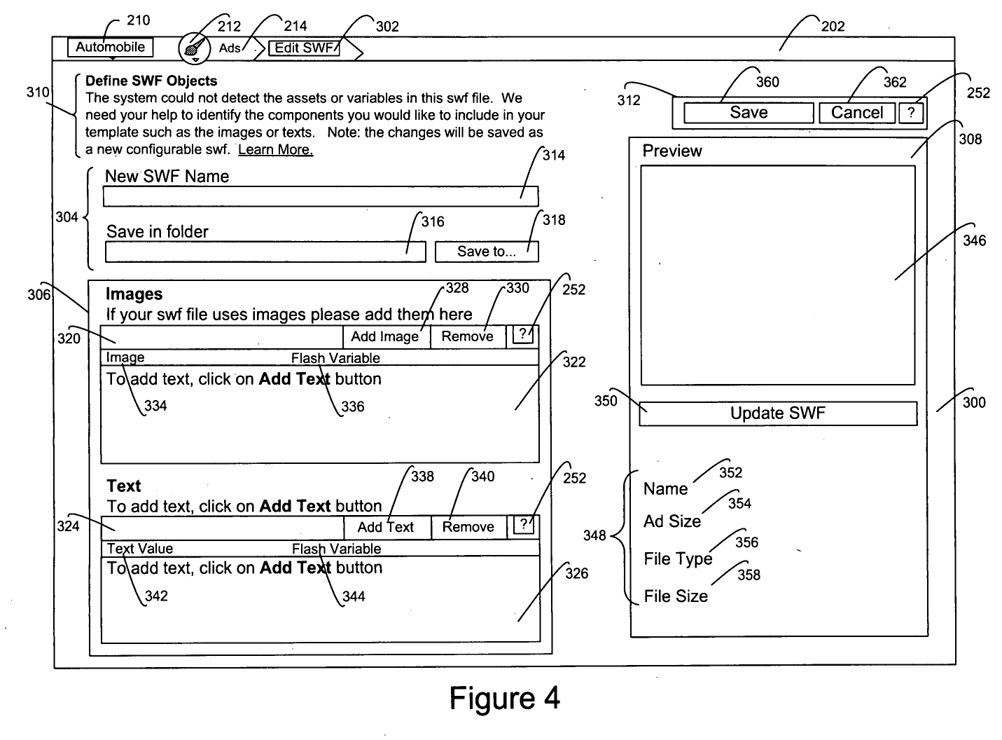

FIG. 4 is an example layout of Shockwave Flash (SWF) GUI 300. SWF GUI 300 may be a user interface that may allow user 10 to define SWF objects by adding components such as text for text-only advertisement objects and text and images for graphical advertisements. Although SWF is used in the example, SWF GUI 300 may allow user 10 to define any graphics file format object. In other words, the SWF object is an example of a computer file format object, where the computer file format objects may include other file format objects and the use of SWF file, SWF object, and SWF GUI does not limit the application of the files, objects, and/or graphical user interface to Shockwave Flash files.

SWF GUI 300 may include an edit SWF button 302 in navigation bar 202. Edit SWF button 302 may cause SWF GUI 300 to be displayed on webpage 106 to begin a process of defining a SWF object. Should user 10 desire to return to ads GUI 200, user 10 may press ads button 214.

SWF GUI 300 may be configured to receive image and text inputs from user 10, convey message and preview outputs to user 10, and provide action options to user 10. SWF GUI 300 may include a storage control box 304, an asset management box 306, a preview pane 308, a SWF message box 310, and preview action buttons 312. As noted above, navigation bar 202 may appear at a top of webpage 106. Storage control box 304 may be positioned below SWF message box 310 and above asset management box 306, each of which may be on a left-hand side of webpage 106. Preview action buttons 312 may be positioned between navigation bar 202 and preview pane 308, where preview action buttons 312 and preview pane 308 may be positioned on a right-hand side of webpage 106.

Storage control box 304 may give user 10 an ability to identify the SWF file and determine where the SWF file may be stored within database 104. Storage control box 304 may include a new SWF name text box 314, a save in folder text box 316 positioned below new SWF name text box 314, and a SWF save to button 318 positioned to the right of save in folder text box 316. New SWF name text box 314 may include an edit field to receive text information from user 10 to be used by system 100 to assign an identifying string of text to a SWF file. User 10 creation of a name for the SWF file may strengthen a notion that a result may be a separate SWF object. Save in folder text box 316 may include an edit field to receive text information from user 10 to be used by system 100 to place the SWF file in a named folder. Pressing SWF save to button 318 may bring up a tree view, such tree view 224, from which user 10 may navigate and select the folder into which the SWF file should be saved. Save in folder text box 316 may include a default save location.

Asset management box 306 may give user 10 an ability to add one or more images to the SWF file and add text to the SWF file, including to SWF file images configured to receive text. Asset management box 306 may include an image menu bar 320 attached above an images grid view 322 and a text menu bar 324 positioned below images grid view 322 and attached above a text grid view 326.

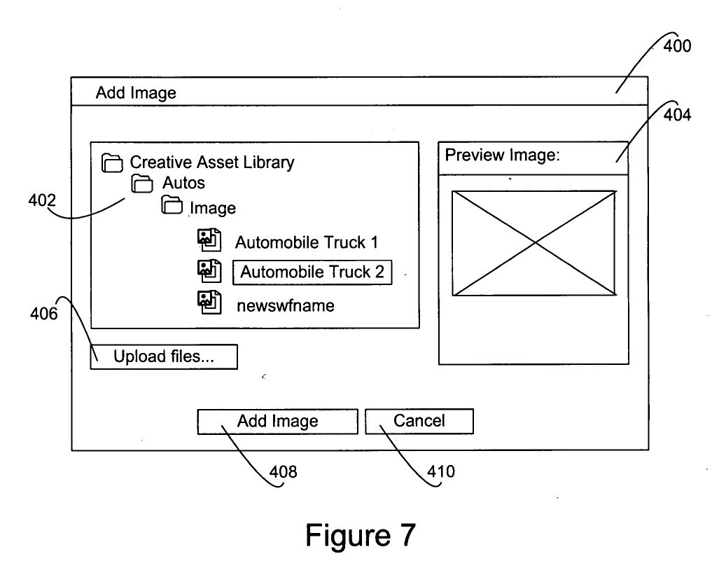

Image menu bar 320 may include an add image button 328, a remove image button 330, and help button 252. Selecting add image button 328 may bring up an image file dialog box 400 (FIG. 7) from which an image asset may be selected for insertion into the SWF file. Selecting remove image button 330 may remove a preselected image asset from the SWF file.

Images grid view 322 may present image assets in an arrangement of columns and rows. Each image asset utilized in the customizable SWF object may be characterized by an image name 334 and an image flash variable 336. Image name 334 may be a text unit by which an image is known. Examples of image name 334 may include Silver Birch Metallic.gif and ImageName2.gif. Image flash variable 336 may be a text string having predefined characteristics that may affect the display of an image asset in the SWF file. For example, “Trucktop_var” may cause the image asset to fill-in the SWF file from the top down, “logo_var” may identify an image asset as a specially styled company name or mark designed as part of a corporate image, and “dynamic_txt_w_txt_box_var” may identify an image asset as configured to receive text from a set of text and dynamically change that text as well as receive fixed text (such as a phone number). Image flash variable 336 may include an edit field to receive text information from user 10.

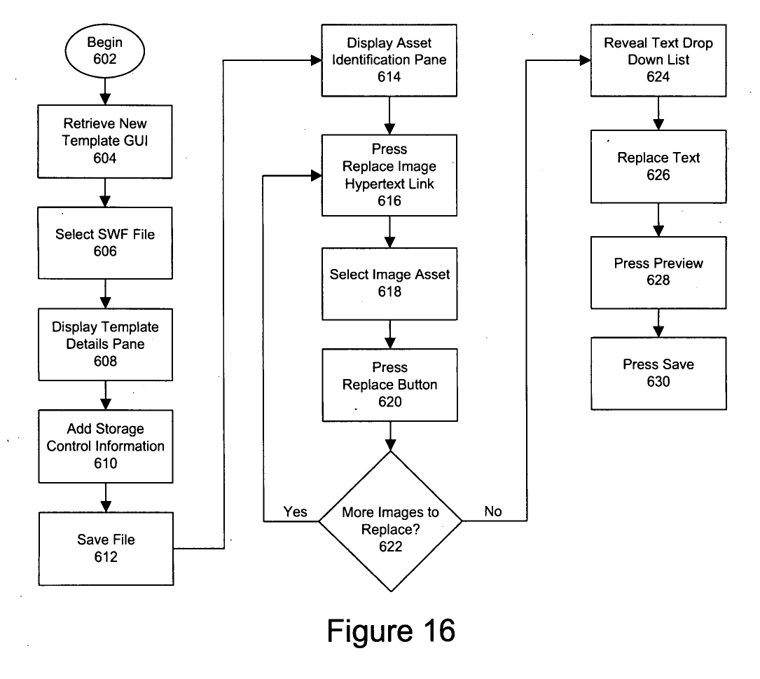

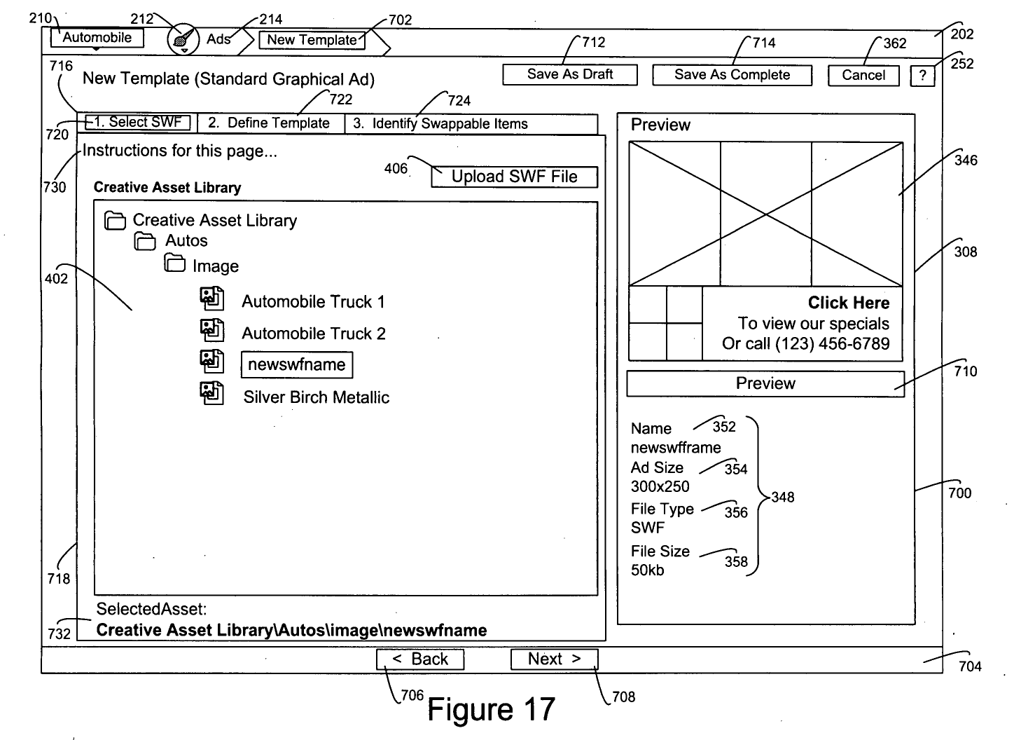

When a customizable SWF object is used to create an advertising template, the predefined image flash variable 336 may remain fixed during the new template creation phase (a description of which may begin at FIG. 16 and FIG. 17). Thus, when user 10 swaps in an image asset into the advertising template, the predefined image flash variable 336 may control where and how that image appears in the advertising template. Images added to the template may include images, flash, and video files.

Text menu bar 324 may include an add text button 338, a remove text button 340, and help button 252. Text grid view 326 may present text assets in an arrangement of columns and rows. Each text asset utilized in the SWF file may be characterized by a text value 342 and a text flash variable 344.

Selecting add text button 338 may bring up an edit field to receive text information from user 10. The use of that text information may be determined by text flash variable 344. Selecting remove text button 340 may remove a preselected text asset from the SWF file. Text value 342 may be words of something written, such as “Or call (123) 456-6789”. Text flash variable 344 may be a text string having predefined characteristics that may affect the display of a text asset in the SWF file. For example, “phoneNumber_var” may cause the “Or call (123) 456-6789” text asset to be positioned in a text box of an image asset composed of dynamic text and a text box. Both text value 342 and text flash variable 344 may include an edit field to receive text information from user 10.

Preview pane 308 may be a layer in a build up of SWF GUI 300 that may present user 10 with a graphical display of the SWF object and the parameters of the SWF object as well as an update action option. Preview pane 308 may include a preview window 346, preview parameters 348, and an update SWF button 350. Preview window 346 may be positioned above update SWF button 350 and update SWF button 350 may be positioned between preview window 346 and preview parameters 348.

Preview window 346 may be a visual area containing an output display of image assets and text assets entered into asset management box 306. Preview window 346 may be rectangular in shape and may have a size of 300×250 IMU in one example to coincide with a medium rectangle advertisement. Content displayed in preview window 346 while defining the SWF objects may appear very similar to the final output. Preview window 346 may strengthen a notion that the results may be a separate SWF file since User 10 may compare a subsequently updated SWF file to an immediately prior version.

Preview parameters 348 may be quantities that define certain characteristics the SWF file displayed in preview window 346. Preview parameters 348 may include a preview name 352, an ad size 354, a file type 356, and a file size 358. Preview name 352 may be the name of the SWF object entered in new SWF name text box 314. Ad size 354 may represent the IMU dimensions of the advertisement, such as those in Table I above. File type 356 may represent how the information of the SWF object is encoded. For example, file type 356 may be SWF. File size 358 may be a measure of the size of the SWF file as measured in kilobytes.

Update SWF button 350 may provide a way for user 10 to accept modifications to a SWF file and incrementally view any changes to the SWF file. When no assets are shown in preview pane 308, update SWF button 350 may be visible in light lines. When an asset appears in preview pane 308, update SWF button 350 may be visible in dark lines.

SWF message box 310 may provide user 10 with feedback on the status of the SWF file and provide instructions and context to user 10. Preview action buttons 312 may include SWF save button 360, SWF cancel button 362, and help button 252. Pressing SWF save button 360 may save any update modifications to the SWF file and pressing SWF cancel button 362 may end the process of defining the SWF objects and return user 10 to a prior GUI.

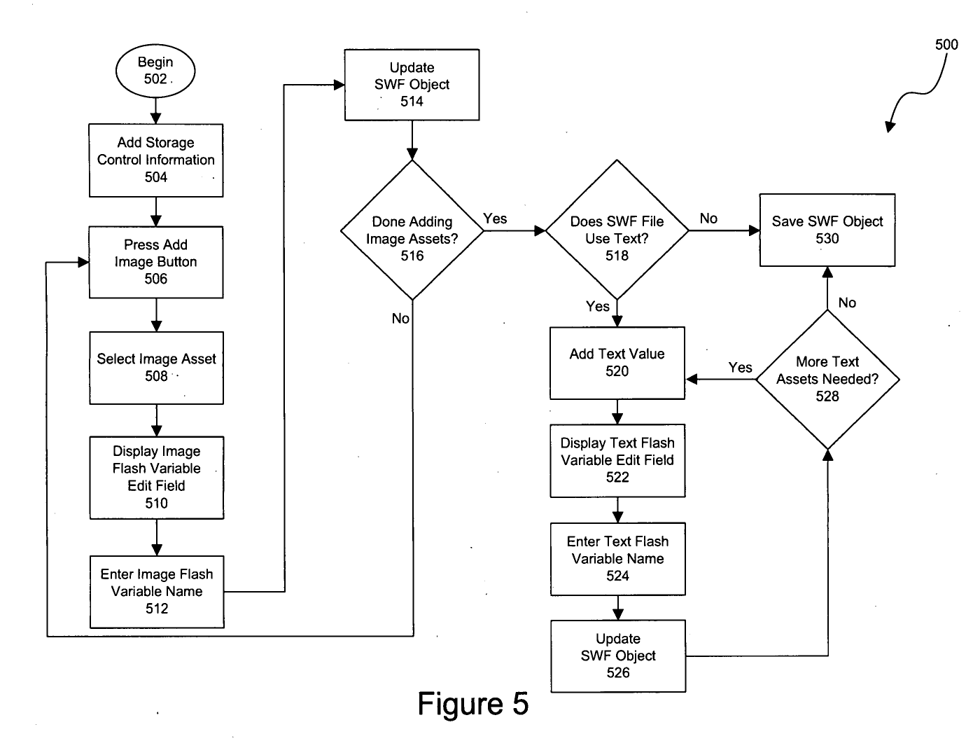

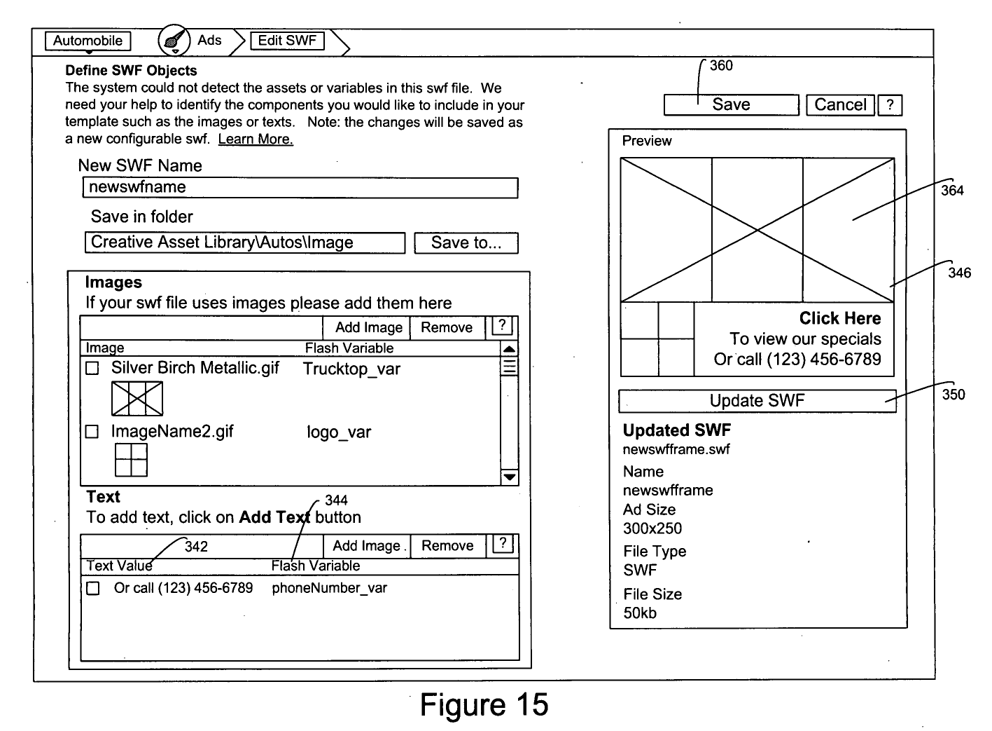

FIG. 5 is a method 500 to define a file format object 364 (FIG. 15) utilizing system 100. File format object 364 may be a SWF object 364 stored as a SWF file. SWF object 364 may be utilized as an advertisement and include one or more assets. The advertisement may be an announcement called to the attention of the public 10. For example, the advertisement may include an announcement to make something known, especially to persuade people 10 to buy whatever is advertised. The advertisement may be a communication to inform potential customers 10 about products and services, about how to obtain them, and use them.

When displayed on an Internet webpage, the advertisement may be an online advertisement. As display advertising-content appearing on a webpage, the advertisement may be in a form such as text, a banner, a half banner, a streaming banner, a button, an interactive button ad, a clickable ad, mail, raw text, a rectangle, or a skyscraper and may range in size from 25×25 to 728×210, for example. The advertisement may be in other sizes or ad forms. In one example, the advertisement may be formatted and served as a small, text-only box.

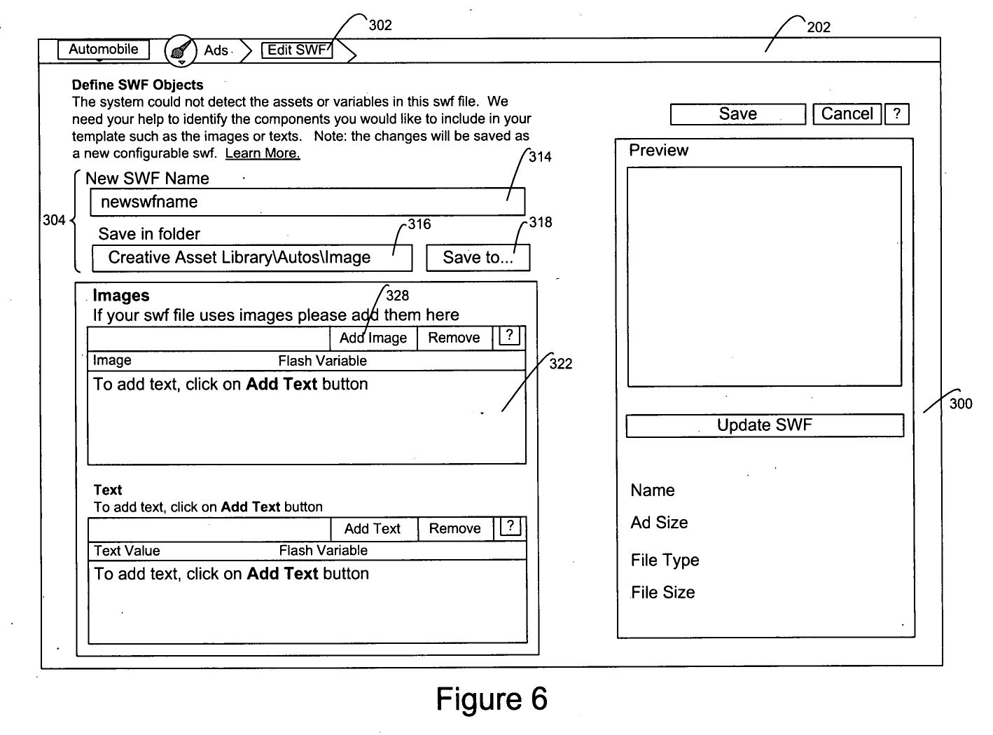

Method 500 may begin at step 502. At step 504, system 100 may receive storage control information. FIG. 6 is an example layout of SWF GUI 300 containing storage control information. In this example, new SWF name text box 314 received “newswfname” as the name for the SWF file and save in folder text box 316 may receive “Creative Asset Library\Autos\Image” as a target folder.

At step 506, add image button 328 may be pressed. This may bring up image file dialog box 400. FIG. 7 is an example layout of image file dialog box 400. Image file dialog box 400 may include a creative asset tree view 402, a creative asset preview 404 positioned to the right of creative asset tree view 402, a creative asset upload file button 406, a creative asset add image button 408, and a creative asset cancel button 410.

Creative asset tree view 402 may be a GUI element (widget) that may present a hierarchical view of information. Creative asset preview 404 may provide a visual area containing an output display of an image highlighted in creative asset tree view 402. Creative asset upload file button 406 may allow user 10 to access files stored on user computer 12 and upload them into database 104. Once an image asset is selected, creative asset add image button 408 may be pressed to add the image both to image grid view pane 322 and to preview window 346. Pressing creative asset cancel button 410 may end the image addition process.

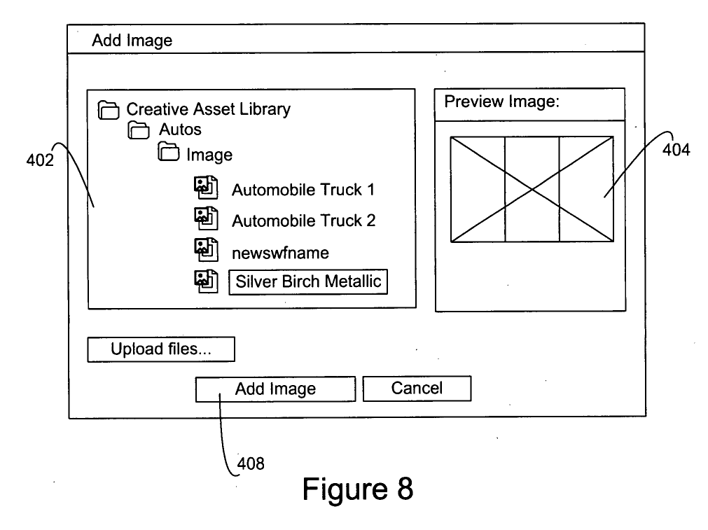

At step 508, user 10 may select an image asset. To obtain the image asset in this example, user 10 pressed upload file button 406, found the file “Silver Birch Metallic” in storage on user computer 12, and added the image file to the “Creative Asset Library\Autos\Image” folder in database 104. FIG. 8 is an example layout of image file dialog box 400 containing the file “Silver Birch Metallic”. Uploaded files may be added to the image folder. To select the image asset “Silver Birch Metallic,” user 10 highlighted the image name, which changed the image in the creative asset preview 404. User 10 then pressed creative asset add image button 408 to finalize selecting the image asset at step 508.

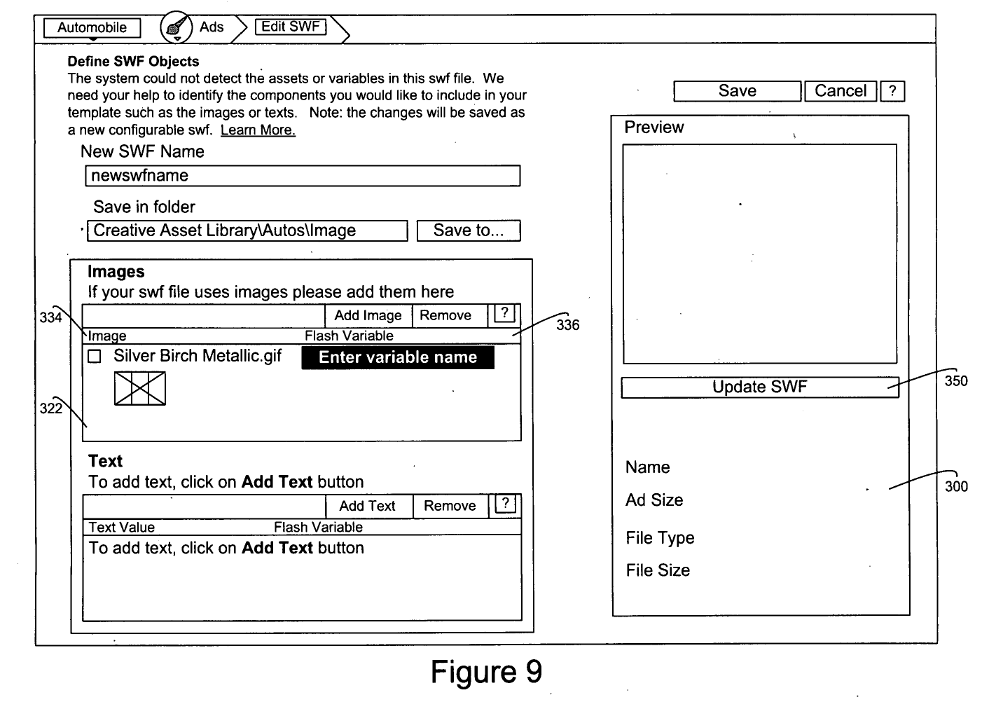

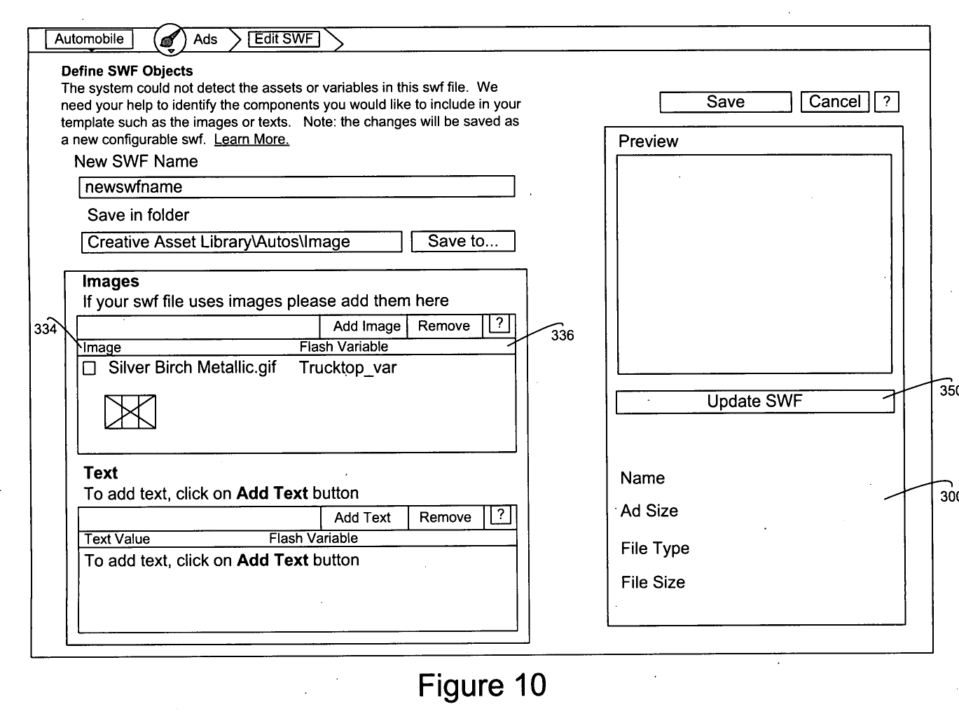

FIG. 9 is an example layout of SWF GUI 300 containing the file “Silver Birch Metallic.gif”. At 510, an edit field may be displayed under image flash variable 336 at a position adjacent to the file “Silver Birch Metallic.gif.” At 512, the image flash variable edit field 336 may receive a variable name from user 10. This may cause update SWF button 350 to be highlighted. In other words, upon entering a value into image flash variable 336, the update SWF button 350 may be enabled. FIG. 10 is an example layout of SWF GUI 300 with update SWF button 350 enabled. Update SWF button 350 may be located in a position other than where shown in FIG. 10.

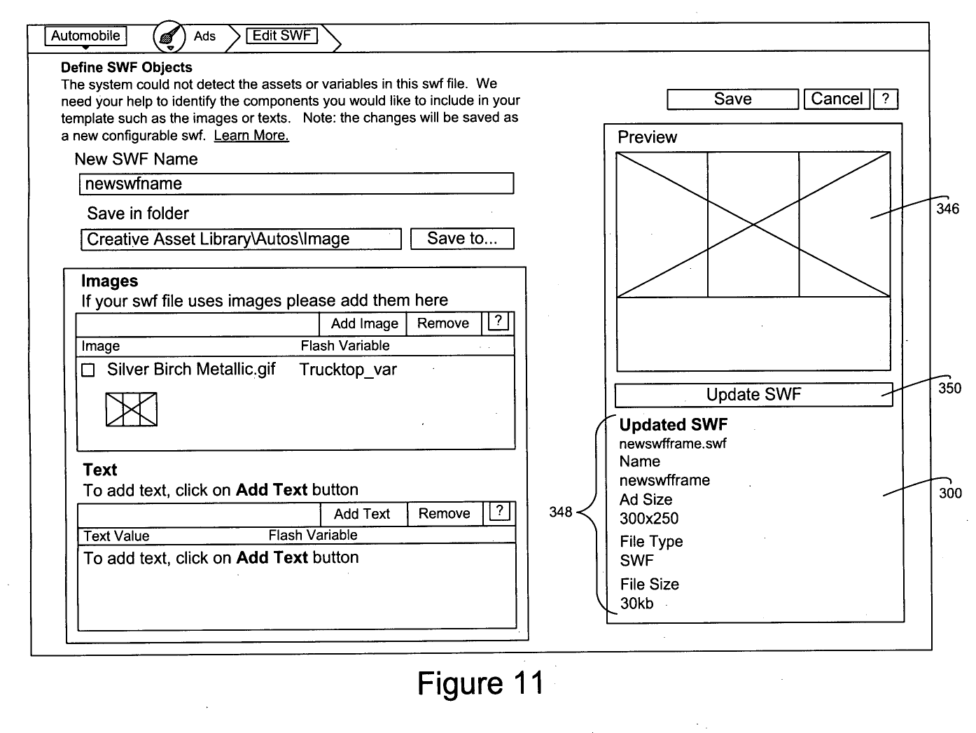

At step 514, update SWF button 350 may be pressed. In response to update SWF button 350 being pressed, system 100 may display Silver Birch Metallic.gif in preview window 346 and may display the parameters of the file in preview parameters 348. FIG. 11 is an example layout of SWF GUI 300 with Silver Birch Metallic.gif displayed in preview window 346 and the file parameters displayed in preview parameters 348.

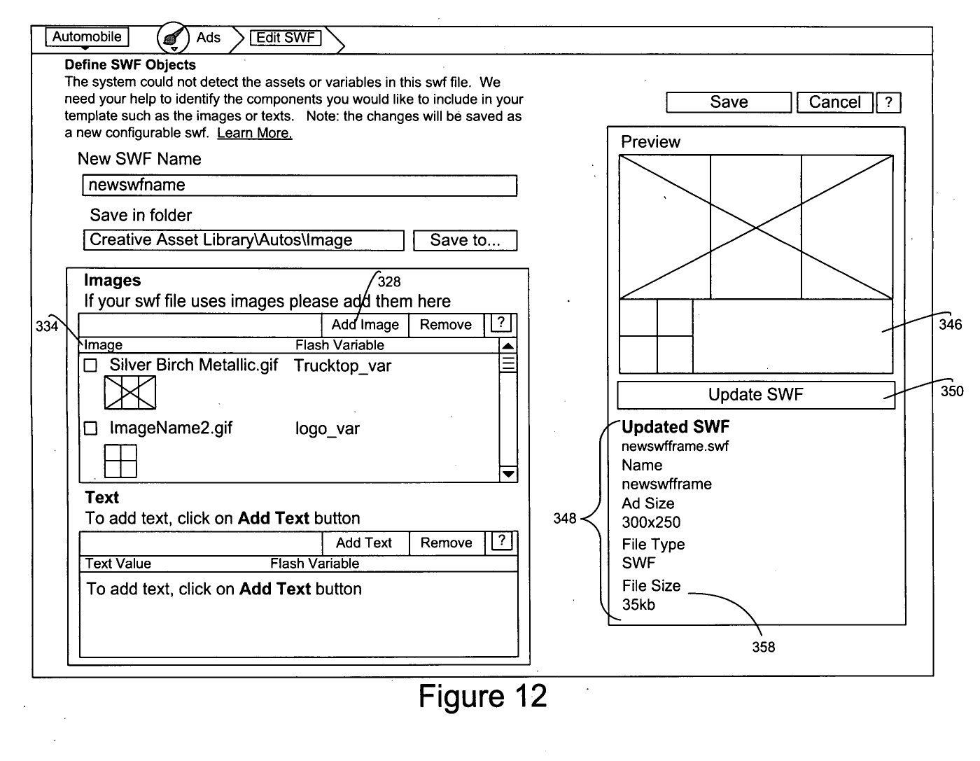

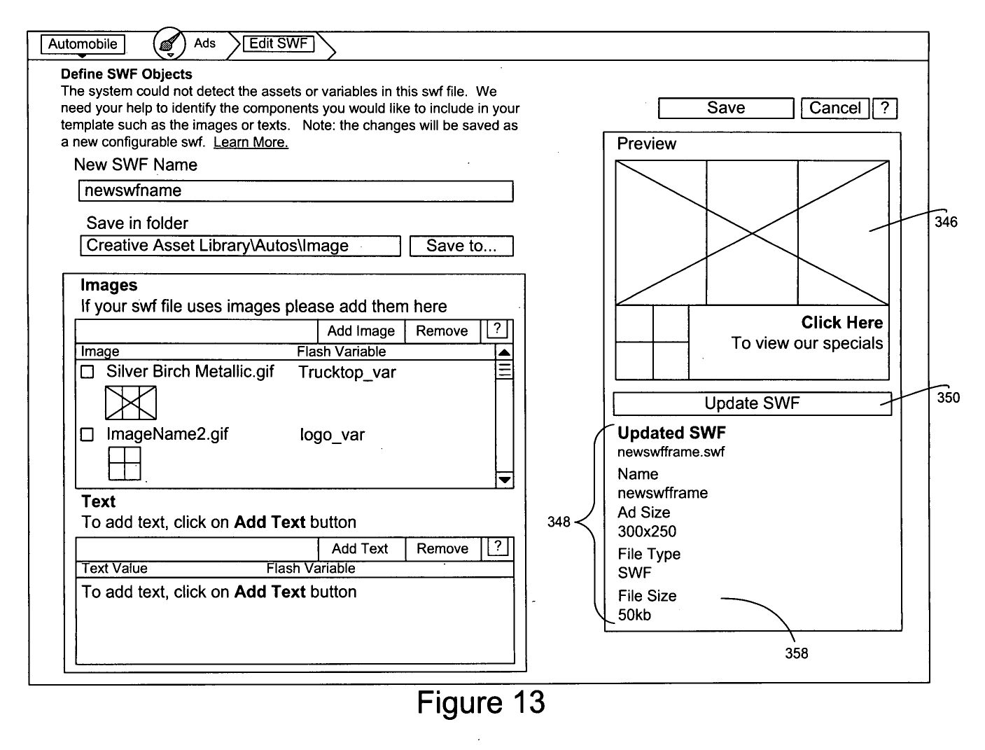

At step 516, method 500 may determine whether any more image assets may be added to the SWF file. If more image assets may be added to the SWF file, then method 500 may return to step 506. FIG. 12 is an example layout of SWF GUI 300 with both Silver Birch Metallic.gif and ImageName2.gif displayed in preview window 346 and the revised file parameters displayed in preview parameters 348. With the addition of another image asset, file size 358 increased from 30 kb to 35 kb. Where system 100 may not be able to detect if a defined variable is correct, User 10 may use preview window 346 to validate the image visually. FIG. 13 is an example layout of SWF GUI 300 with Silver Birch Metallic.gif, ImageName2.gif, and Dynamic txt w txt box.jpg displayed in preview window 346 and the revised file parameters displayed in preview parameters 348. With the addition of another image asset, file size 358 increased from 35 kb to 50 kb.

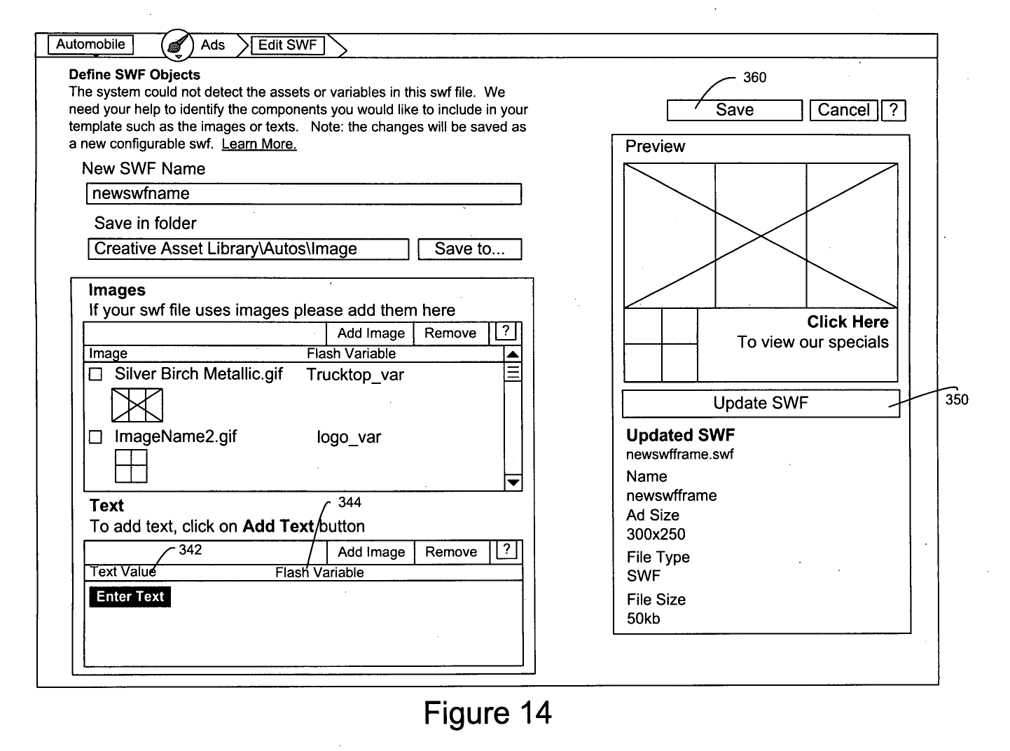

If no more image assets may be added to the SWF file, then method 500 may proceed to step 518. At step 518, method 500 may determine whether SWF file 364 utilizes text. For example, if one of the image assets also includes a dynamic and/or static text field, then SWF file 364 may utilize text and an edit field may be displayed under text value 342. FIG. 14 is an example layout of SWF GUI 300 with an edit field may be displayed under text value 342. In this example, the image file “Dynamic txt w txt box.jpg” also includes a text box to assist in modifying the image with text. If SWF file 364 does not utilizes text, then method 500 may proceed to step 530.

If SWF file 364 does utilizes text, then method 500 may proceed to step 520. At step 520, system 100 may receive a text value in the text value edit field 342. This may cause an edit field to be displayed under text flash variable 344 at step 522. In other words, once User 10 enters the text, User 10 may be prompted to add a value to a corresponding text flash variable 334. At 524, the text flash variable edit field 344 may receive a variable name from user 10. At step 526, user 10 may press update SWF button 350. FIG. 15 is an example layout of SWF GUI 300 with the text “Or call (123) 456-6789” displayed in both text value 342 and preview window 346 and with text flash variable “phoneNumber_var” displayed in text flash variable 344.

At step 528, system 100 may determine whether additional text assets may be needed. If additional text assets are needed, method 500 may return to step 520. If no additional text assets are needed, method 500 may proceed to step 530. At step 530, user 10 may press SWF save button 360 to save the updated SWF file 364.

At the end of method 500, user 10 may have create a customizable SWF object in system 100 having defined flash variables whose operation is known by system 100. The flash variables may map out all the image and text components inside the customizable SWF file to inform system 100 of the number of image components, what text components there are, and the values of those text components.

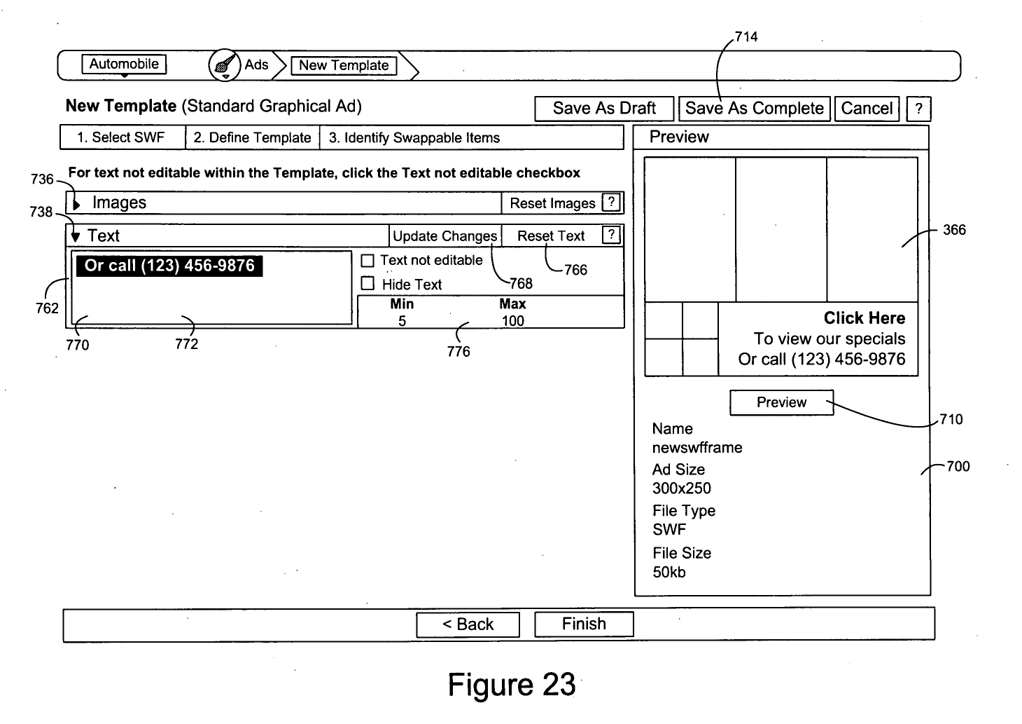

FIG. 16 is a method 600 to create a new template 366 (FIG. 23) for Internet advertising utilizing a system 100 containing graphical user interfaces. Method 600 may begin at step 602. At step 604, user 10 may bring new template GUI 700 to webpage 106. For example, from ads GUI 200 (FIG. 2), user 10 may press new template button 244 to bring new template GUI 700 to webpage 106.

FIG. 17 is an example layout of new template GUI 700. New template GUI 700 may be a user interface that may allow user 10 to modify an existing SWF object. Here, user 10 may modify the existing SWF object into a new template for graphical advertisement by identifying swappable items and swapping image assets and text assets.

New template GUI 700 may include navigation bar 202 having a new template button 702 that may cause new template GUI 700 to be displayed on webpage 106. New template GUI 700 may include a footer navigation bar 704 having a back button 706 to move to a prior screen and a next button 708 to move to a subsequent screen. In addition, new template GUI 700 may include preview pane 308 with update SWF button 350 replaced by a preview template button 710. Adjacent to cancel button 362 and help button 252, new template GUI 700 may include a save as draft button 712 and a save as complete button 714 that respectively may function to save the template as a draft and save the template as a completed work.

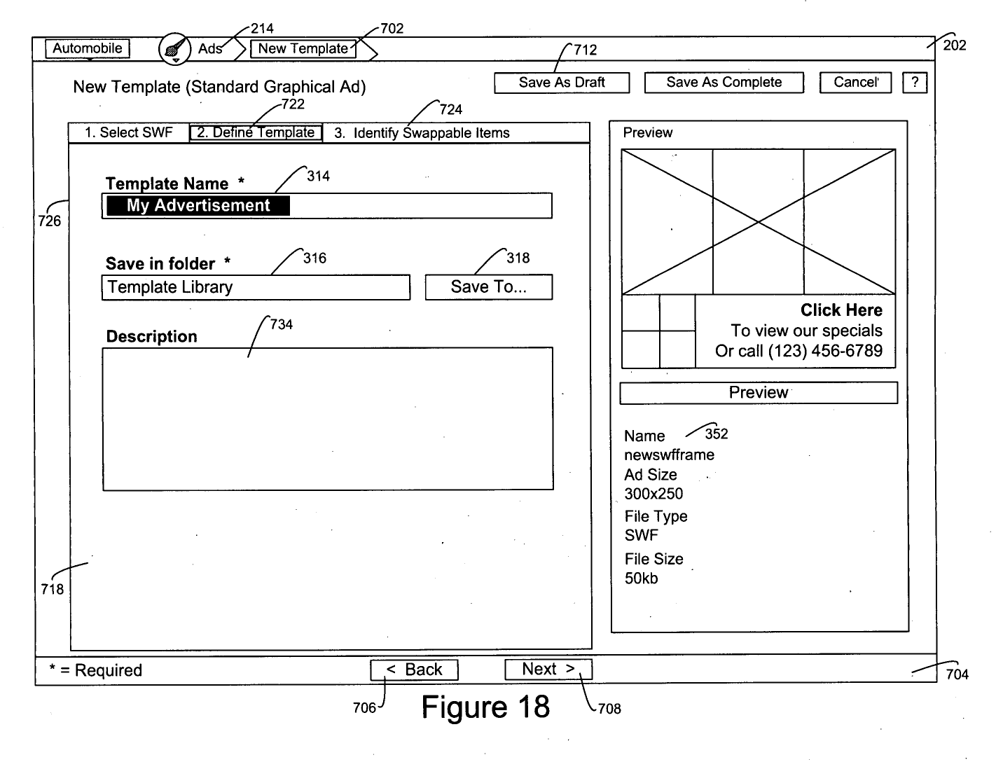

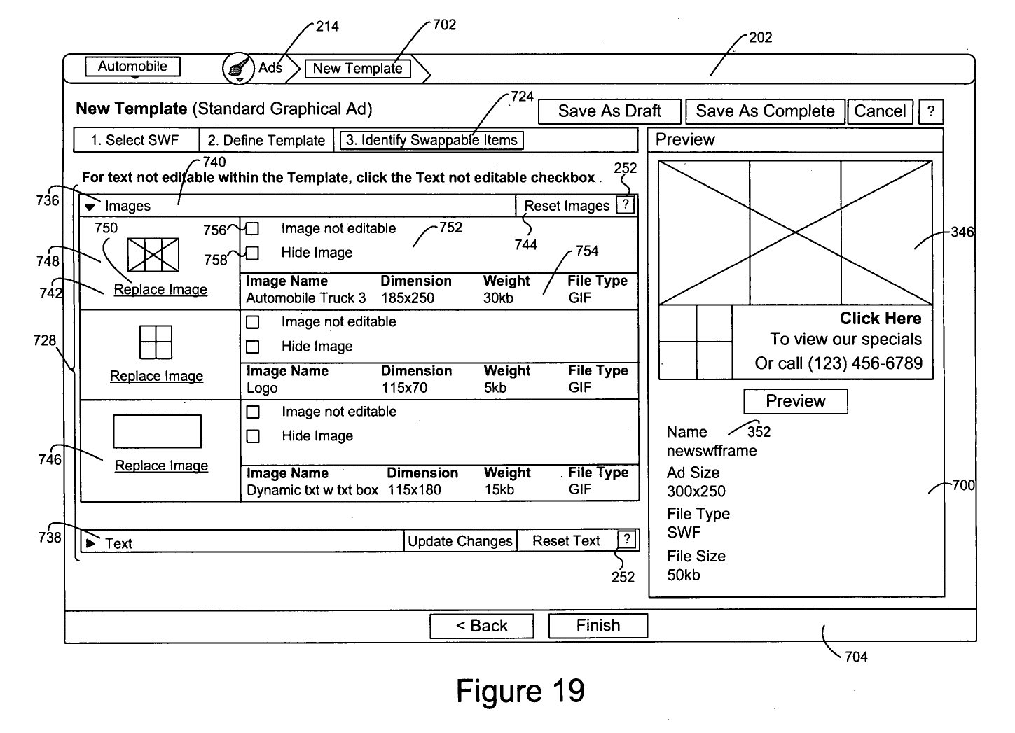

On the left of webpage 106 and between navigation bar 202 and footer navigation bar 704, new template GUI 700 may include a new template tab bar 716 and a workspace 718. New template tab bar 716 may include a select SWF button 720, a define template button 722, and an identify swappable items button 724, each of which may control what is displayed in workspace 718. For example, pressing select SWF button 720 may display a tree view, such as creative asset tree view 402, pressing define template button 722 may display a template details pane 726 (FIG. 18), and pressing identify swappable items button 724 may display an asset identification pane 728 (FIG. 19).

With select SWF button 720 pressed, creative asset tree view 402 may be displayed. In addition, workspace 718 may include a new template instruction box 730 above creative asset tree view 402 and a new template massage box 732 below creative asset tree view 402. New template instruction box 730 may include text that may provide instructions howto utilize new template GUI 700. New template massage box 732 may include text that may identify whether an asset selected is an SWF file or an image asset and a path to that asset.

When new template GUI 700 is brought to webpage 106 at step 604, creative asset tree view 402 may be displayed in workspace 718. User 10 may select an SWF file at step 606. In this example, user 10 may select newswfname created through method 500. Highlighting the newswfname file and pressing preview SWF button 710 may display newswfname in preview window 346.

At step 608, method 600 may display template details pane 726 in workspace 718. User 10 may display template details pane 726 in workspace 718 by pressing define template button 722, for example. FIG. 18 is an example layout of new template GUI 700 with template details pane 726. Template details pane 726 may include new SWF name text box 314 (renamed template name text box 314), save in folder text box 316, and SWF save to button 318 (renamed template save to button 320). In addition, template details pane 726 may include a template description text box 734 that may include text summarizing the template being defined.

At 610, method 600 may add storage control information about the template being defined. In this example, user 10 named the template “My Advertisement”. At 612, method 600 may saved the file in template library node 234 (FIG. 2). In this example, user 10 may press save as draft button 712. In response, preview name 352 may change from “newswfname” to “My Advertisement”.

At 614, method 600 may display asset identification pane 728 in workspace 718. User 10 may display asset identification pane 728 in workspace 718 by pressing identify swappable items button 724, for example. FIG. 19 is an example layout of new template GUI 700 with asset identification pane 728. Asset identification pane 728 may include an image combo box 736 and a text combo box 738.

Image combo box 736 may include an image combo box control bar 740 and an image drop down list 742. Image combo box control bar 740 may include a reset images button 744, the pressing of which may reset an initial stage image drop down list 742. Pressing image combo box control bar 740 may reveal or hid image drop down list 742. Image drop down list 742 may include image grid entries 746, each of which may include an image cell 748 having a replace image hypertext link 750, and include an image checkbox cell 752 and a image parameters cell 754. Each image grid entry 746 may contain one image asset from new template 366. Image cell 748 may host a copy of the image asset and image parameters cell 754 may include information about the image asset, such as the image name, the image dimensions in IMUs, the image weight in kilobytes, and the file type, such as GIF and JPG.

Image checkbox cell 752 may include box elements that may permit user 10 to make multiple selections from a number of options. In an example, image checkbox cell 752 may include an image not editable checkbox 756 and a hide image checkbox 758. When selected, image not editable checkbox 756 may characterize an image asset as not being editable within the template. Hide image checkbox 758 may be configured to prevent an image asset from being visible with the template while maintaining an association with that image asset.

At step 616, method 600 may press replace image hypertext link 750 to begin a process of replacing an image asset within new template 366. In this example, user 10 may elect to replace the automobile product image by selecting replace image hypertext link 750 associated with that image. Pressing replace image hypertext link 750 may bring up image file dialog box 400 (FIG. 7) from which an image asset may be selected for insertion into new template 366.

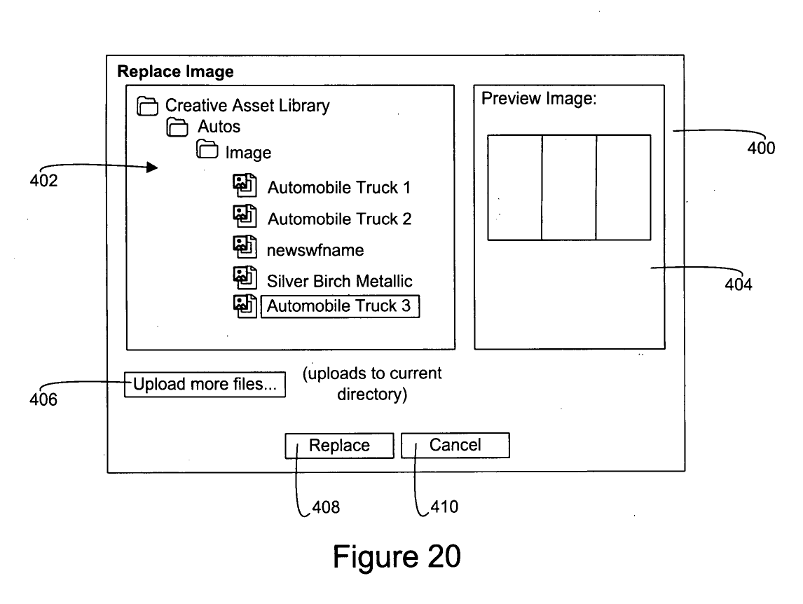

FIG. 20 is an example layout of image file dialog box 400 on being accessed through replace image hypertext link 750. Image file dialog box 400 may include creative asset tree view 402, creative asset preview 404 positioned to the right of creative asset tree view 402, creative asset upload file button 406, creative asset add image button 408 (renamed as “replace”), and a creative asset cancel button 410.

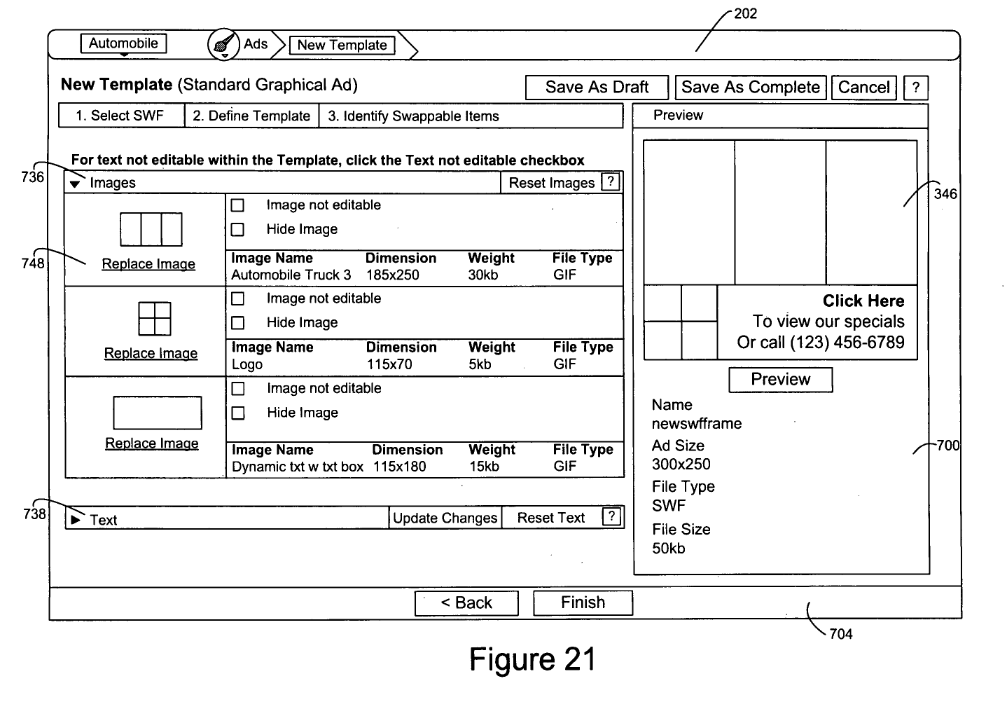

At 618, user 10 may select an image asset. In this example, user 10 obtained the new image asset from user computer 12 by pressing upload file button 406, locating the file “Automobile Truck 3” in storage on user computer 12, and added the image file to the “Creative Asset Library\Autos\Image” folder in database 104. To select the image asset “Automobile Truck 3”, user 10 highlighted the image and then pressed creative asset replace image button 408 at step 620. A results is illustrated by FIG. 21. FIG. 21 is an example layout of new template GUI 700 with new image asset “Automobile Truck 3” swapped into image cell 748 and into preview window 346. In response to the image swap, the information in image parameters cell 754 changed to represent the swapped image “Automobile Truck 3”.

At step 622, method 600 may determine whether additional images are to be replaced. If additional images are to be replaced, method 600 may return to step 616. If additional images are not to be replaced, method 600 may proceed to step 624.

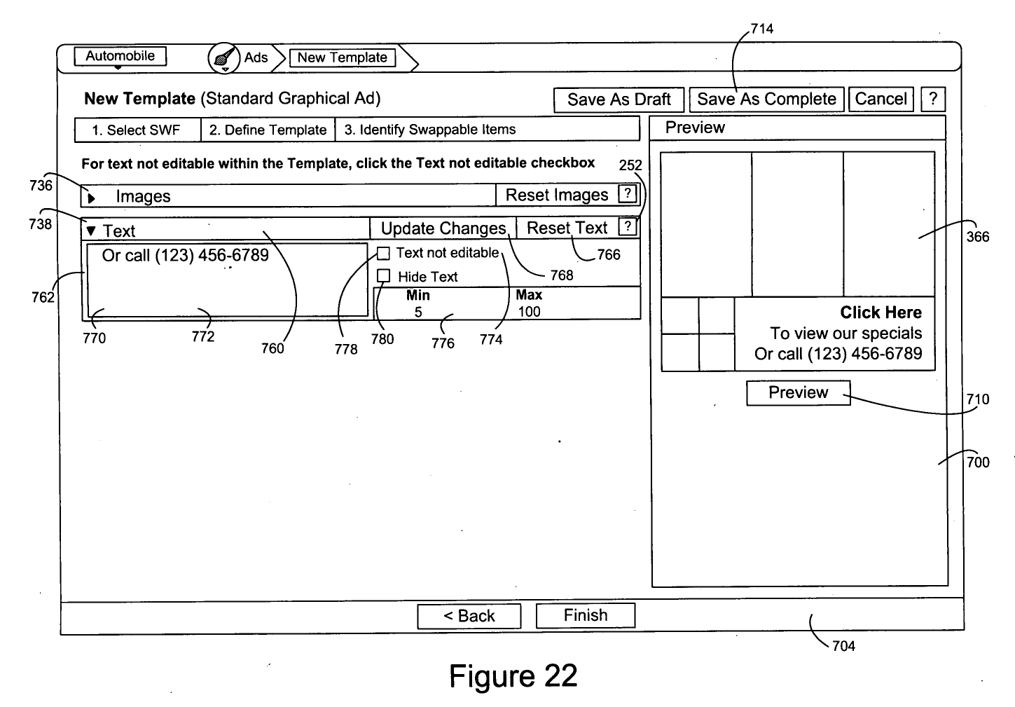

Text combo box 738 may include a text combo box control bar 760 that may reveal or hide a text drop down list 762 when pressed. At step 624, text combo box control bar 760 may be pressed to reveal text drop down list 762. FIG. 22 is an example layout of new template GUI 700 with text drop down list 762 exposed.

Text combo box control bar 760 may include a reset texts button 766, the pressing of which may reset an initial stage text drop down list 762. Text combo box control bar 760 also may include an update changes button 768 to provide control over which text changes may be implemented into new template 366.

Text drop down list 762 may include multiple text grid entries 770, each of which may include a text cell 772, a text checkbox cell 774, and a text parameters cell 776. Each text grid entry 770 may contain one text asset from new template 366. Text cell 772 may host a copy of the text asset and text parameters cell 776 may include information about the text asset, such as its length and a minimum length and maximum length boundary.

Text checkbox cell 774 may include box elements that may permit user 10 to make multiple selections from a number of options. In an example, text checkbox cell 774 may include a text not editable checkbox 778 and a hide text checkbox 780. When selected, text not editable checkbox 778 may characterize an text asset as not being editable within the template. Hide text checkbox 780 may be configured to prevent an text asset from being visible with the template while maintaining an association with that text asset. In addition, clicking on hide text checkbox 780 may disable the text not editable checkbox 778 and the text field in text cell 772.

At step 626, method 600 may receive instructions to replace a text asset within new template 366. In this example, user 10 replace the telephone number suffix “6789” with “9876”. FIG. 23 is an example layout of new template GUI 700 with the template phone number revised. Method 600 may receive instructions to preview new template 366 at step 628. User 10 may preview new template 366 by pressing preview template button 710. Method 600 then may receive instructions to save new template 366 as complete at step 630. User 10 may save new template 366 as complete by pressing save as complete button 714.

Part or all of system 100 may be implemented as a computer program product on a storage medium having instructions stored thereon/in. These instructions may be used to control, or cause, a computer to perform any of the processes. The storage medium may include without limitation any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium, system 100 may include software both to control the hardware of a general purpose/specialized computer or microprocessor and to enable the computer or microprocessor to interact with a human consumer or other mechanism utilizing the results of system 100. Such software may include without limitation device drivers, operating systems, and user applications. Ultimately, such computer readable medium further may include software to perform system 100.

User 10 may be an advertising agency creating the template, where that user has the knowledge and expertise to build a template and someone with less knowledge and expertise may use that template to create an advertisement through system 100. This may lower barriers to creating an advertisement and capture redundant processes that take a lot of time to help users save time.

System 100 permits user 10 to swap out images and text assets. In addition to being configured to receive instructions from user 10 to create a template, user 10 may upload a template into system 100 and use existing templates in system 100. In an example, a first user 10 may create a square template with a logo in the lower left corner and product text in the middle of the template. A second user 10 may access that template through system 100 and may swap in their own logo so that the logo may appear in the lower left corner part of the template.

A template of system 100 may provide a starting point and may contain a set of constraints and rules that may guide user 10 along a path to create an advertisement. A template of system 100 may guide user 10 into building an advertisement object having a certain size dimension and characteristics. For example, a user starting with a template predetermined to be a 50×50 standard graphical advertisement having a logo in the lower left hand corner may output a 50×50 standard graphical advertisement with their choice of log appearing in the lower left hand corner of the advertisement.

System 100 may include advertising templates and allow others to create and upload their own templates to reduce the amount of expertise needed to generate a final advertisement object. System 100 may be part of a template platform infrastructure where people with advertisement building expertise may come together, build templates, and share and perhaps license their templates for use by others. This may foster growth of system 100 as an open source advertisement creation system.

Before creating a template within system 100, user 10 may create a customizable SWF object and templates may be based upon this customizable SWF object. The SWF object may include a mapping that may inform system 100 as to what may be inside that SWF object. For example the mapping may indicate that the image components of the SWF object include a background picture, a logo, and an image with text components. The text components of the image may include a product description and a call to action such as “Buy this product.” The customizable SWF object may be an offline piece where users may build the customizable SWF object to define flash variables in the setup that may call out all the image and text components.

The use of templates in system 100 ease the ad development process. In addition to easing the creative design process, the templates may provide constraints on business rules for the advertisers, such as the hide/editability restrictions provided by system 100. System 100 may be integrated into a larger platform to ultimately help marketers buy across search, display, local, mobile, and video inventory—all from a single, integrated interface. The larger platform may have an ability to deliver highly relevant advertising to consumers across the entire Web, driving better results for marketers. In addition, the larger platform may provide a suite of tools that easily allows precise geographic, demographic, and interest-based advertisement targeting across a vast network. System 100 may contribute to this open platform available to any participant by simplifying the time-consuming operational tasks of online advertising, allowing media planners, creative users, and account managers to return to their valuable roles as advisers and enabling agencies to accelerate the development of value-added services. System 100 may enable creative users to design in their favorite creative tools and contribute to a process to accelerate a free market economy for advertising.

The information disclosed herein is provided merely to illustrate principles and should not be construed as limiting the scope of the subject matter of the terms of the claims. The written specification and figures are, accordingly, to be regarded in an illustrative rather than a restrictive sense. Moreover, the principles disclosed may be applied to achieve the advantages described herein and to achieve other advantages or to satisfy other objectives, as well.

What is claimed is:

1. A method to create a template for Internet advertising utilizing a system having a template server containing graphical user interfaces, the method comprising:
receiving a request in the template server to retrieve a computer file format object having a first asset associated with a defined variable; and
receiving a request in the template server to replace the first asset with a second asset, where the second asset automatically is associated with the defined variable.

2. The method of claim 1, further comprising:
receiving a request in the template server to make the second asset not editable.

3. The method of claim 1, further comprising:
receiving a request in the template server to hide the second asset.

4. The method of claim 1, where the first asset is a first image asset and receiving a request in the template server to replace the first asset with a second asset includes receiving a request in the template server to retrieve a second image asset from a database accessible by the template server.

5. The method of claim 1, further comprising:
receiving a request in the template server to add the first asset and the defined variable to the computer file format object.

6. The method of claim 5, further comprising:
receiving a request in the template server to update a visual presentation of the computer file format object.

7. A computer readable medium comprising a set of instructions which, when executed by a computer, cause the computer to create a template for Internet advertising utilizing a system having a template server containing graphical user interfaces, the instructions for:
receiving a request in the template server to retrieve a computer file format object having a first asset associated with a defined variable; and
receiving a request in the template server to replace the first asset with a second asset, where the second asset automatically is associated with the defined variable.

8. The computer readable medium of claim 7, further comprising:
receiving a request in the template server to make the second asset not editable.

9. The computer readable medium of claim 7, further comprising:
receiving a request in the template server to hide the second asset.

10. The computer readable medium of claim 7, where the first asset is a first image asset and receiving a request in the template server to replace the first asset with a second asset includes receiving a request in the template server to retrieve a second image asset from a database accessible by the template server.

11. The computer readable medium of claim 7, further comprising:
receiving a request in the template server to add the first asset and the defined variable to the computer file format object.

12. The computer readable medium of claim 10, further comprising:
receiving a request in the template server to update a visual presentation of the computer file format object.

13. A template server to create a template for Internet advertising utilizing a system containing graphical user interfaces, the template server comprising:
instructions to retrieve a computer file format object having a first asset associated with a defined variable; and
instructions to replace the first asset with a second asset, where the second asset automatically is associated with the defined variable.

14. The template server of claim 13, further comprising:
instructions to make the second asset not editable.

15. The template server of claim 13, further comprising:
instructions to hide the second asset.

16. The template server of claim 15, where the first asset is a first image asset and the instructions to replace the first asset with a second asset include instructions to retrieve a second image asset from a database accessible by the template server.

17. The template server of claim 15, further comprising:
instructions to add the first asset and the defined variable to the computer file format object.

18. The template server of claim 17, further comprising:
receiving a request in the template server to update a visual presentation of the computer file format object.
